(19) United States
(12) Patent Application Publication
(10) Pub. No.: US 2016/0290780 A1
(43) Pub. Date: Oct. 6, 2016

(54) STRAIN SENSOR USING NANOCOMPOSITE AND METHOD FOR MANUFACTURING THEREOF

(71) Applicant: RESEARCH & BUSINESS FOUNDATION SUNGKYUNKWAN UNIVERSITY, Suwon-si (KR)

(72) Inventors: Nae Eung LEE, Seoul (KR); Byeong Ung HWANG, Pohang-si (KR); Quang Trung TRAN, Suwon-si (KR)

(73) Assignee: RESEARCH & BUSINESS FOUNDATION SUNGKYUNKWAN UNIVERSITY, Suwon-si (KR)

(21) Appl. No.: 15/072,845

(22) Filed: Mar. 17, 2016

(30) Foreign Application Priority Data
Apr. 1, 2015 (KR) 10-2015-0046254

(51) Int. Cl. G01B 7/16; G01L 1/22

(52) U.S. Cl. CPC G01B 7/18; G01L 1/2287; G01L 1/22

(57) ABSTRACT

A strain sensor and a method of manufacturing the same are provided. The strain sensor includes a substrate, a nanocomposite layer disposed on the substrate, and a protective layer disposed on the nanocomposite layer. The nanocomposite layer includes metallic nanowires, a first polymeric material, and a second polymeric material. The protective layer includes a third polymeric material. The metallic nanowires are randomly arranged in the nanocomposite layer.

### CROSS-REFERENCE TO RELATED APPLICATION

This application claims the benefit under 35 USC 119(a) of Korean Patent Application No. 10-2015-0046254 filed on Apr. 1, 2015 in the Korean Intellectual Property Office, the entire disclosure of which is incorporated herein by reference for all purposes.

### BACKGROUND

1. Field

The following description relates to a strain sensor and a method of manufacturing thereof, such as, for example, to a strain sensor, that uses a nanocomposite, and a method of manufacturing the same.

2. Description of Related Art

Conventionally, strain sensors based on silver nanowires were manufactured by mixing silver nanowires into polyurethane (PU) or polydimethylsiloxane (PDMS), which has good elasticity. There have been attempts to use silver nanowires, which have high conductivity, in sensors that rely on variations in contact resistance among the silver nanowires to detect strain, where the variations are caused by a mechanical deformation. However, for the sensors to have sufficient levels of sensitivity and conductivity in response to strain, the sensors need to contain silver nanowires at high concentration, which adversely affects optical transmittance of the sensors. Thus, obtaining sensors with satisfactory sensitivity and optical transmittance is difficult.

In addition, conventional strain sensors are vulnerable to mechanical deformation; when the sensors are subjected to repeated deformations, defects such as surface cracks, or delamination may occur, resulting in the degradation of sensor properties and eventually threatening the stability of the sensors.

Also, conventional strain sensors can satisfactorily detect large strain but produce little change in resistance in response to strain with a small magnitude; therefore, it is not possible for them to detect a minute strain such as a movement of human skin.

To address the aforementioned issues, conventional strain sensors were manufactured through complicated techniques, such as a patterning technique to improve sensitivity and a nanofiller arrangement technique, which lead to a difficult manufacturing process and a high production cost.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect, a strain sensor is disclosed. The strain sensor includes a substrate, a nanocomposite layer disposed on the substrate, and a protective layer disposed on the nanocomposite layer. The nanocomposite layer includes metallic nanowires, a first polymeric material, and a second polymeric material. The protective layer includes a third polymeric material. The metallic nanowires are randomly arranged in the nanocomposite layer.

In an embodiment, the protective layer further includes one or more of the first polymeric material and the second polymeric material.

In an embodiment, the first polymeric material is one or more selected from the group consisting of poly(3,4-ethylenedioxythiophene):poly(4-styrenesulfonate) (PEDOT:PSS), polyacetylene, polyparaphenylene, polypyrrole, and polyaniline.

In an embodiment, second polymeric material is one or more selected from the group consisting of polydimethylsiloxane (PDMS), ecoflex and polyurethane (PU).

In an embodiment, the substrate is one or more selected from the group consisting of PDMS, ecoflex, and PU.

In an embodiment, the third polymeric material is one or more selected from the group consisting of PDMS, ecoflex, and PU.

In another aspect, a method of manufacturing a strain sensor is disclosed. The method may include forming, on a substrate, a nanocomposite layer including metallic nanowires, a first polymeric material, and a second polymeric material, and forming, on the nanocomposite layer, a protective layer including a third polymeric material. The metallic nanowires are randomly arranged in the nanocomposite layer.

In an embodiment, the forming of a nanocomposite layer includes treating the substrate with oxygen-plasma, spin-coating a first solution comprising the metallic nanowires on the oxygen-plasma treated substrate and performing a first heat treatment, and spin-coating, on the substrate on which the metallic nanowires are randomly arranged, a second solution comprising the first polymeric material and the second polymeric material, and performing a second heat treatment.

In an embodiment, the spin-coating of the first solution is performed at a rotational speed of about 200 to about 400 rpm.

In an embodiment, a concentration of the first polymeric material in the second solution is about 10 to about 50%.

In an embodiment, a concentration of the second polymeric material in the second solution is about 50 to about 90%.

In an embodiment, the forming of a protective layer includes spin-coating a third solution comprising a third polymeric material on the substrate, on which the nanocomposite layer is formed, and performing a second heat treatment.

In an embodiment, the first heat treatment comprises heating at about 50 to about 120 ° C. for about 10 to about 30 minutes.

In an embodiment, the second heat treatment comprises heating, under a nitrogen (N₂) atmosphere, at about 50 to about 120° C. for about 10 to about 30 minutes and heating at about 120 to about 200° C. for about 60 to about 120 minutes.

Other features and aspects will be apparent from the following detailed description, the drawings, and the claims.

### BRIEF DESCRIPTION OF THE DRAWINGS

The above and other objects, features and advantages of the present invention will become more apparent to those of ordinary skill in the art by describing in detail embodiments thereof with reference to the accompanying drawings, in which:

FIG. 1 is a schematic diagram, illustrating an example of a structure of a strain sensor, which uses a nanocomposite.

FIG. 2A is a flowchart illustrating an example of a method of manufacturing a strain sensor, which uses a nanocomposite.

FIG. 2B is a schematic view illustrating an example of a method of manufacturing a strain sensor, which uses a nanocomposite.

FIG. 3 is a graph showing a transmittance of a strain sensor that uses a nanocomposite.

FIG. 4 is a graph showing a change in resistance, which was measured while stretching a strain sensor, which uses a nanocomposite, 10,000 times at a strain of 40%, in accordance with an embodiment.

FIG. 5 is a field emission scanning electron microscope (FE-SEM) image of an example of a strain sensor that uses a nanocomposite.

FIG. 6 is a graph showing a resistance change ratio of an example of a strain sensor that uses a nanocomposite, when the central part of the strain sensor is uplifted by compression.

FIG. 7 is a graph showing a resistance change ratio of an example of a strain sensor that uses a nanocomposite, when the central part of the strain sensor is caved in by compression.

FIG. 8 is a graph showing a resistance change ratio of an example of a strain sensor that uses a nanocomposite, when the strain sensor is stretched,

FIG. 9 is a graph showing a transmittance of an example of a strain sensor that uses a nanocomposite, when silver nanowires are randomly arranged on a substrate through spin-coating, and the measured results are shown for various rotational speeds.

FIG. 10 is a graph showing a resistance change ratio of an example of a strain sensor that uses a nanocomposite, when poly(3,4-ethylenedioxythiophene):poly(4-styrenesulfonate) (PEDOT:PSS) and polyurethane (PU) are spin-coated on silver nanowires, and the measured results are shown for various concentrations of PEDOT:PSS and PU.

FIG. 11 is test results of a mechanical stability of an example of a strain sensor that uses a nanocomposite.

Throughout the drawings and the detailed description, unless otherwise described or provided, the same drawing reference numerals will be understood to refer to the same elements, features, and structures. The drawings may not be to scale, and the relative size proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

The terminology used herein is for the purpose of describing particular examples only, and is not intended to limit the scope of the disclosure in any way. As used herein, the singular forms “a,” “an,” and “the” are intended to include the plural forms as well, unless the context clearly indicates otherwise. It will be further understood that the terms “include” and/or “have,” when used in this specification, specify the presence of stated features, numbers, operations, elements, components, or combinations thereof, but do not preclude the presence or addition of one or more other features, numbers, operations, elements, components or combinations thereof.

Unless otherwise defined, all terms, including technical and scientific terms, used herein have the same meaning as commonly understood by one of ordinary skill in the art to which this description pertains. It will be further understood that terms, such as those defined in commonly used dictionaries, should be interpreted as having a meaning that is consistent with their meaning in the context of the relevant art and are not to be interpreted in an idealized or overly formal sense unless expressly so defined herein.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

As used herein, the term “about” means plus or minus 10% of the numerical value of the number with which it is being used. Therefore, about 50% means in the range of 45%-55%.

As used herein, the term “nanowires” refers to cylindrical or ribbon-shaped structures having a feature size of less than about 100 nm in two dimensions, and a feature size of more than about 10 μm in the third dimension. For example, a nanowire may be a cylindrical structure having a diameter of about 1 nm, about 5 nm, about 10 nm, about 20 nm, about 50 nm, or about 100 nm, or any length including and between the values recited herein. A nanowire may have a length of about 10 μm, about 15 μm, about 20 μm, about 30 μm, about 50 μm, about 100 μm or about 200 μm, or any length including and between the values recited herein. The metallic nanowires described herein may be fabricated using any method known in the art, and the embodiments disclosed herein are not limited by the method of making the metallic nanowires.

The embodiments described herein enable detection of a minute strain, while achieving satisfaction in both transparency and sensitivity.

The embodiments described herein enable transparency and sensitive detection of strain, and thus, enable an attachment to a human body to detect a minute movement of, for example, skin and joints.

The embodiments described herein use a ternary system nanocomposite, and thus, enable enhancement of the mechanical stability of metallic nanowires, which leads to stable detection of strain even when subjected to deformation repeatedly. In addition, the embodiments described herein enable prediction of a mode of deformation of a strain sensor through a resistance change ratio.

The embodiments described herein enable the manufacture of a strain sensor by a simple method and at a low cost.

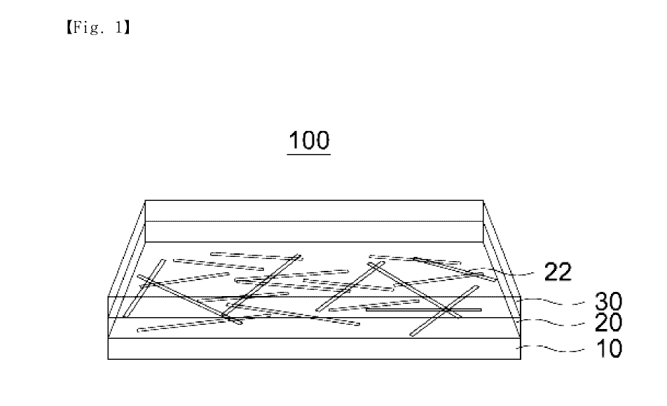

FIG. 1 illustrates a structure of a strain sensor, which uses a nanocomposite, according to an embodiment described herein.

Referring to FIG. 1, a strain sensor 100, which uses a nanocomposite, according to an embodiment may include a substrate 10, a nanocomposite layer 20, and a protective layer 30.

The substrate 10 may consist of a material that is transparent and elastic. For example, the substrate 10 may include, without limitation, polydimethylsiloxane (PDMS), ecoflex, polyurethane (PU), or a combination thereof. One of ordinary skill in the art will appreciate that the material of substrate 10 may not be limited to the examples provided herein so long as it has the physical properties enabling the sufficient functioning of the sensor within the scope of this disclosure.

In an embodiment, the nanocomposite layer 20 is disposed on the substrate 10, and is a ternary system nanocomposite layer 20 including silver nanowires 22, a first polymeric material, and a second polymeric material. The first polymeric material may include a transparent, elastic, and conductive material such as, for example, poly(3,4-ethylenedioxythiophene):poly(4-styrenesulfonate) (PEDOT:PSS), polyacetylene, polyparaphenylene, polypyrrole, polyaniline, or a combination thereof. The second polymeric material may include a transparent and elastic material, such as, for example, one or more selected from the group consisting of PDMS, ecoflex, and PU.

In an embodiment, the metallic nanowires 22 are randomly arranged in the nanocomposite layer 20. The concentration of the metallic nanowires 22 in the nanocomposite layer 20 may be suitably adjusted in consideration of the optical transmittance and conductivity of the nanocomposite layer 20. The metallic nanowires may be formed of materials having high conductivity and ductility such as, for example, gold, silver, copper, nickel, platinum, aluminum, carbon nanotubes, doped semiconductors such as doped zinc oxide, or a combination thereof.

During the formation of the nanocomposite layer 20, the spaces created among the metallic nanowires 22 are filled with the first polymeric material and the second polymeric material. This results in the mechanical stability of the metallic nanowires 22 being enhanced, compared with when only the metallic nanowires 22 are disposed on top of the substrate 10. In addition, in an embodiment, the nanocomposite layer 20 includes the first polymeric material that is conductive. Thus the conductivity of the nanocomposite layer may be improved, compared with when the nanocomposite layer contains only the metallic nanowires 22. metallic nanowires

In an embodiment, the protective layer 30 includes a third polymeric material that is transparent and elastic. The protective layer 30 prevents the nanocomposite layer 20 from experiencing a change in properties by preventing the surrounding environment such as, for example, outdoor air pollutants including oxygen, moisture, and foreign substances, from contacting the nanocomposite layer 20. The third polymeric material may include, without limitation, PDMS, ecoflex, PU, or a combination thereof.

In an embodiment, the protective layer 30 additionally includes either one or both of the first polymeric material and the second polymeric material. Including either one or both of the first polymeric material and the second polymeric material may further improve the mechanical stability of the strain sensor 100, which uses a nanocomposite, disclosed herein.

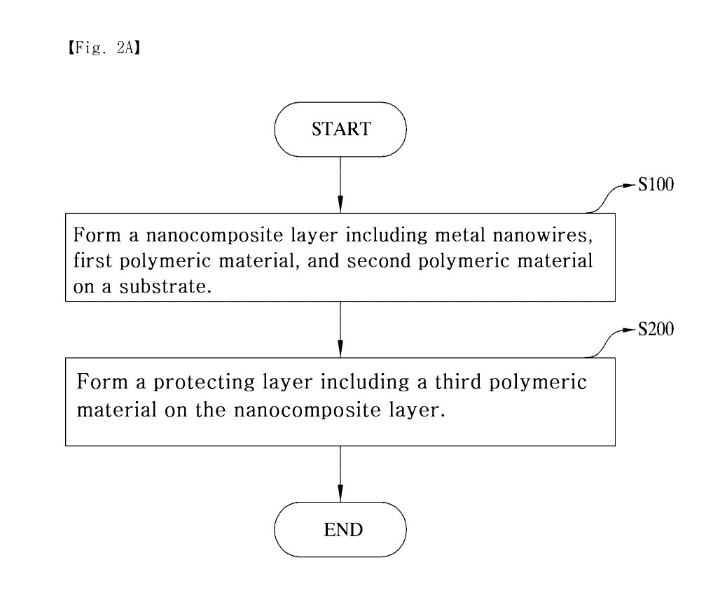

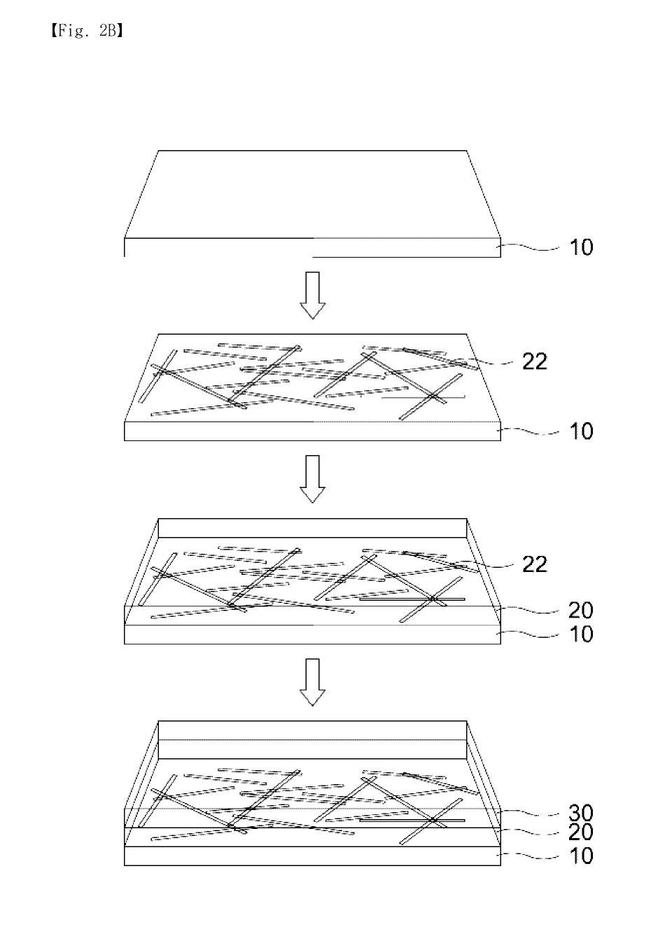

FIG. 2A illustrates a flowchart describing a method of manufacturing a strain sensor, which uses a nanocomposite, in accordance with an embodiment. FIG. 2B illustrates a schematic view describing a method of manufacturing a strain sensor, which uses a nanocomposite, in accordance with an embodiment.

Referring to FIGS. 2A and 2B, in an embodiment, a method of manufacturing a strain sensor, which uses a nanocomposite, includes, at operation S100, forming, on a substrate 10, a nanocomposite layer 20 including metallic nanowires 22, a first polymeric material, and a second polymeric material, and, at operation S200, forming, on nanocomposite layer 20, a protective layer 30 including a third polymeric material. The metallic nanowires 22 of the manufactured strain sensor, which uses a nanocomposite, are randomly arranged in the nanocomposite layer 20.

In an embodiment, operation S100 metallic nanowires further includes, at operation S110, treating treating the substrate 10 with oxygen plasma; at operation S120 spin-coating, on the oxygen-plasma treated substrate 10, a first solution including the metallic nanowires 22 and then performing a first heat treatment; at operation S130, spin-coating a second solution including a first polymeric material and a second polymeric material, on the substrate on which the metallic nanowires 22 are randomly arranged and then performing a second heat treatment.

To manufacture a strain sensor 100, which uses a nanocomposite, in accordance with an embodiment, a pliable and elastic substrate 10 is prepared. Next, the substrate 10 is treated with oxygen-plasma (S110). In an embodiment, the substrate 10 is formed of a material such as, for example, PDMS, ecoflex, PU, or a combination thereof. A surface of the substrate 10 may be changed from being hydrophobic to hydrophilic by treatment with oxygen-plasma, which also enables the easy formation of the nanocomposite layer 20 on the substrate 10.

Next, at S120, the first solution containing metallic nanowires 22 is spin-coated on the oxygen-plasma treated substrate 10, followed by the first heat treatment. In an embodiment, silver nanowires may be randomly arranged on the substrate 10, for example, by spin-coating the substrate 10 with a solution including silver nanowires. In embodiment, the metallic nanowires have a length of about 30 μm. In various embodiments, length of metallic nanowires may vary from about 20 μm to about 100 μm. Spin-coating of the metal nanowire solution is followed by heating at a temperature in the range of about 50 to about 120° C. for about 10 to about 30 minutes for evaporating the solvent. During the spin-coating of the first solution on the substrate 10, the rotational speed may be set within the range of about 200 to about 400 rpm to enable random arrangement of the metallic nanowires on the substrate 10. The thickness at which the metallic nanowires are deposited on the substrate 10 may be adjusted by controlling the rotational speed during spin-coating. One of ordinary skill in the art will appreciate that the rotational speed for spin-coating the metal nanowire solution may be varied depending on factor such as, for example, the concentration of the metallic nanowires in the first solution, the viscosity of the solvent used in the first solution, and the desired thickness of the metal nanowire layer, which may be selected based on the particular application for which the strain sensor is to be used. The deposition thickness of the metallic nanowires determines the sheet resistance and the optical transmittance of the nanocomposite layer.

Next, at operation S130, the second solution including the first polymeric material and the second polymeric material is spin-coated on the substrate 10. metallic nanowiresA second heat treatment is then performed. In an embodiment, the first polymeric material may include, without limitation, PEDOT:PSS, polyacetylene, polyparaphenylene, polypyrrole, and polyaniline. The second polymeric material may include, without limitation, PDMS, ecoflex, and PU.

In an embodiment, the concentration of the first polymeric material in the second solution may range from about 10 to about 50%, and the concentration of the second polymeric material in the second solution may range from about 50 to about 90%. The concentrations are set as thus so that the resistance can change stably even as the strain sensor 100 is stretched.

In an embodiment, a ternary system nanocomposite layer 20, which includes randomly arranged metallic nanowires, PEDOT:PSS, and PU, is formed by spin-coating a solution including a mixture of PEDOT:PSS and PU on the substrate 10 having metallic nanowires disposed thereon, and then heating the substrate 10, under a nitrogen (N₂) atmosphere, at a temperature in the range of about 50 to about 120° C. for about 10 to about 30 minutes and then at a temperature in the range of about 120 to about 200° C. for about 60 to about 120 minutes.

In an embodiment, at operation S200, a protective layer 30 including the third polymeric material is formed on the nanocomposite layer 20. The third polymeric material may include, without limitation, one or more of PDMS, ecoflex, PU, or a combination thereof. The protective layer 30 may be formed by spin-coating the third solution on the substrate 10, and then performing heat treatment.

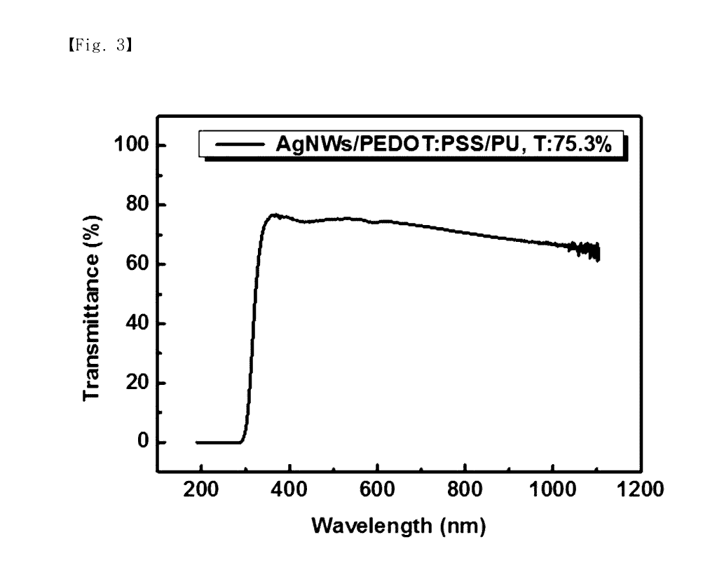

FIG. 3 illustrates a graph showing a transmittance of a strain sensor, which uses a nanocomposite, in accordance with an embodiment. The transmittance was measured by an ultraviolet-visible (UV-VIS) spectrophotometer.

a. Referring to FIG. 3, one of ordinary skill in the art will recognize that the strain sensor has transmittance of about 75% in a wavelength range of about 380 nm or longer, which corresponds to visible and infrared portions of the electromagnetic spectrum.

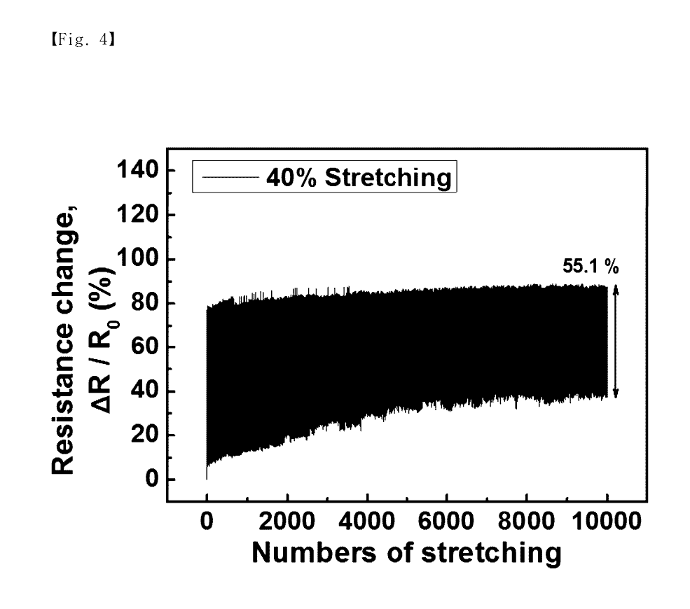

FIG. 4 illustrates a graph showing a change in resistance, which was measured while stretching a strain sensor 10,000 times at a strain of 40%.

Referring to FIG. 4, when the strain sensor is stretched 10,000 times at a large strain of 40%, the ratio of resistance change is maintained steadily between about 30 and about 80%, although it tends to decrease as the number of stretches increase. From this result, it will be apparent to one of ordinary skill in the art that the mechanical stability of a strain sensor is maintained even as the number of stretches increases.

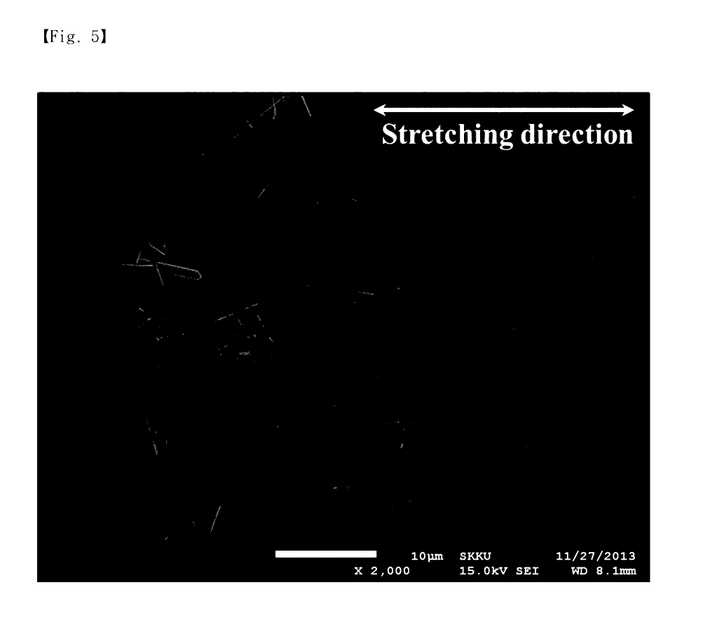

FIG. 5 illustrates a field emission scanning electron microscope (FE-SEM) image of a strain sensor. The FE-SEM image was obtained after stretching the sensor 10,000 times at a strain of 40%.

Referring to FIG. 5, it will be apparent to one of ordinary skill in the art that the nanocomposite layer does not experience surface cracks or broken silver nanowires even when the strain sensor is stretched repeatedly 10,000 times at a large strain of 40%. From this result, it can be recognized that the strain sensor is not damaged even with repeated use, indicating that the strain sensor possesses good mechanical stability.

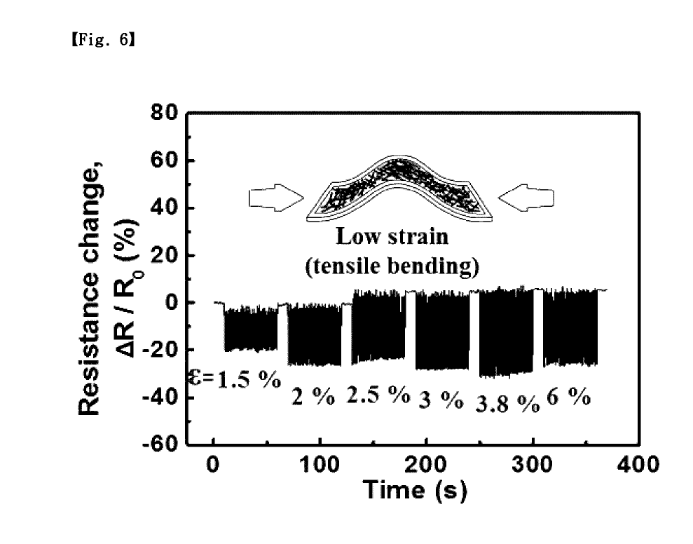

FIG. 6 illustrates a graph showing a resistance change ratio of a strain sensor when the central part of the strain sensor is uplifted by compression. In this case, the resistance change ratio was measured while varying the magnitude of the strain (ε) applied on the strain sensor.

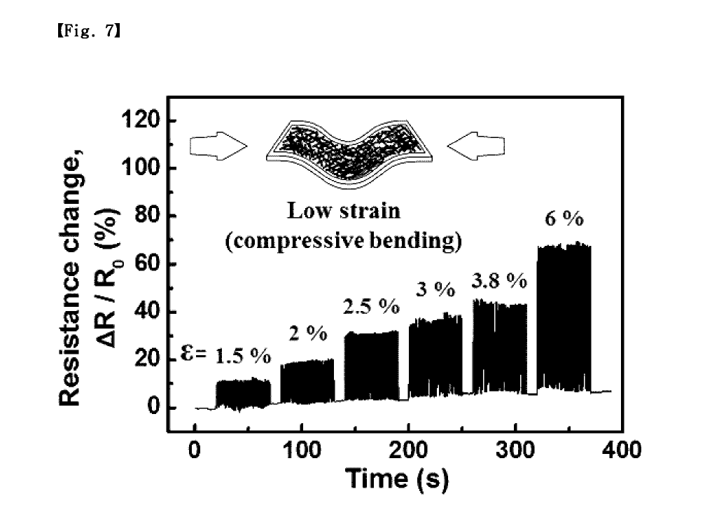

FIG. 7 illustrates a graph showing the measured resistance change ratio of a strain sensor when the central part of the strain sensor is caved in by compression. In this case, the resistance change ratio was measured while varying the magnitude of the strain (c) applied on the strain sensor.

Referring to FIG. 6 and FIG. 7, it will be apparent to one of ordinary skill in the art that the resistance change ratio has a negative (−) value when the strain sensor is compressed to cause the central part to become convexly rounded. On the other hand, the resistance change ratio has a positive (+) value when the strain sensor is compressed to cause the central part to become concavely curved. Given these observations, it is possible to predict whether the central part of the strain sensor would become convexly rounded or concavely curved by observing whether the resistance change ratio of the strain sensor has a negative (−) value or a positive (+) value. A skilled artisan will, thus, be able to predict a mode of deformation of the strain sensor.

In addition, while the existing strain sensors require the change in magnitude of strain (c) to be about 10% to detect a change in resistance change ratio, the presently disclosed strain sensor can detect a change in the resistance change ratio for changes in magnitude of strain (c) as small as about 0.5%.

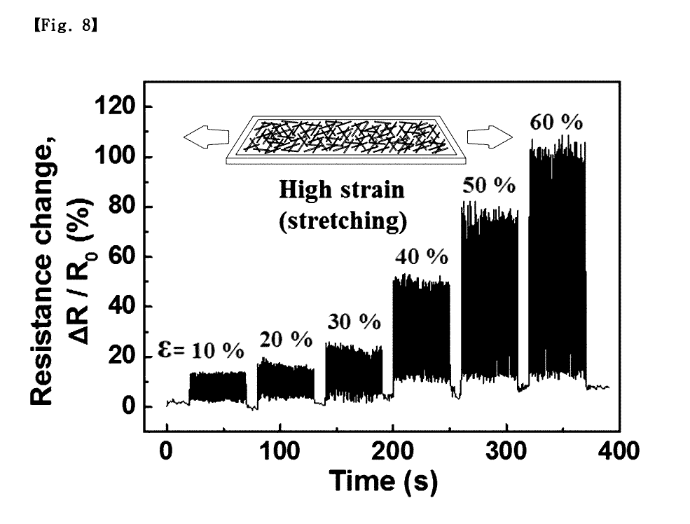

FIG. 8 illustrates a graph showing a resistance change ratio of the strain sensor when the strain sensor is stretched. The resistance change ratio was measured while varying the magnitude of the strain (c) applied on the strain sensor.

Referring to FIG. 8, it will be apparent to one of ordinary skill in the art that the resistance change ratio increases when the strain sensor is stretched, while varying the magnitude of strain (ε) from about 10% to about 60% in steps of 10%. As described elsewhere herein, existing strain sensors can detect strain when the magnitude of strain changes by about 10%, which can be also detected by the strain sensor.

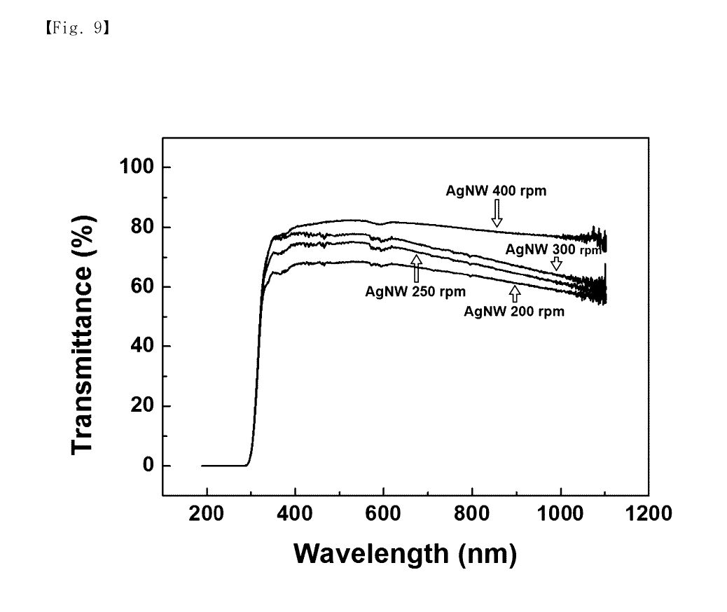

FIG. 9 illustrates a graph showing the measured transmittance of the strain sensor. The results are shown for various rotational speeds.

Referring to FIG. 9, when silver nanowires were spin-coated on the substrate at a rotational speed of about 200 rpm, the measured transmittance at a wavelength of about 300 nm was about 67.37%, and when silver nanowires were spin-coated on a substrate at a rotational speed of about 250 rpm, the measured transmittance at a wavelength of about 300 nm was about 72.7%. In addition, when silver nanowires were spin-coated on a substrate at a rotational speed of about 300 rpm, the measured transmittance at a wavelength of about 300 nm was about 75.83%, and when silver nanowires were spin-coated on a substrate at a rotational speed of about 400 rpm, the measured transmittance at a wavelength of about 300 nm was about 81.38%.

Table 1 shows the measured sheet resistance of silver nanowires that are spin-coated on a substrate, and the results are shown for various rotational speeds.

TABLE 1

| Silver nanowire spin-coating | | |
|---|---|---|
| rotational speed | Sheet resistance | |
| 200 rpm | 16.91~30 | Ω/sq |
| 250 rpm | 66~111 | Ω/sq |
| 300 rpm | 1.4~1.6 | kΩ/sq |

| | |
|---|---|
| 400 rpm | Out of range |

Referring to the results shown in FIG. 9 and Table 1, a strain sensor disclosed herein, and having a transmittance of about 70% or more and a suitable level of sheet resistance, can be manufactured by setting the spin-coating rotational speed of silver nanowires within the range of about 220 to about 280 rpm.

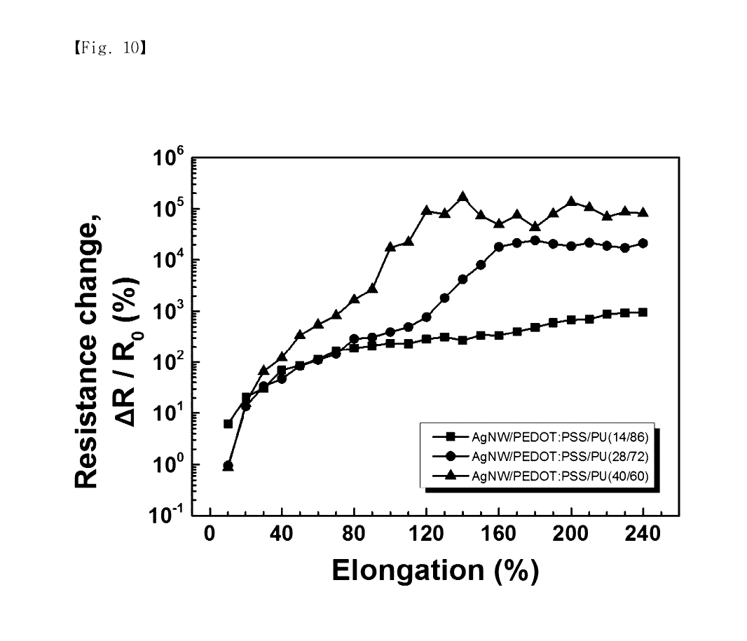

FIG. 10 illustrates a graph showing the measured resistance change ratio of a strain sensor, which uses a nanocomposite, when poly(3,4-ethylenedioxythiophene):poly(4-styrenesulfonate) (PEDOT:PSS) and polyurethane (PU) are spin-coated on silver nanowires, and the results are shown for various concentrations of PEDOT:PSS and PU.

Referring to FIG. 10, when a solution containing PEDOT:PSS at a concentration of 14% and PU at a concentration of 86% was spin-coated on silver nanowires, the resistance change ratio of the strain sensor increases stably even when the sensor is stretched by about 100% or more. However, when a solution containing PEDOT:PSS at a concentration of 28% and PU at a concentration of 72% was spin-coated on silver nanowires, and when a solution containing PEDOT:PSS at a concentration of 40% and PU at a concentration of 60% was spin-coated on silver nanowires, the resistance change ratio of the strain sensor changes suddenly when the sensor is stretched by about 100% or more. From this result, it can be recognized that a strain can be stably detected when a solution containing PEDOT:PSS at a concentration of 14% and PU at a concentration of 86% is spin-coated on silver nanowires. One of ordinary skill in the art will readily recognize that varying the concentration of PEDOT:PSS and PU results in a change in sheet resistance as well as the mechanical stability of the nanocomposite, and that such variation may be used advantageously in designing a strain sensors suitable for a desired application.

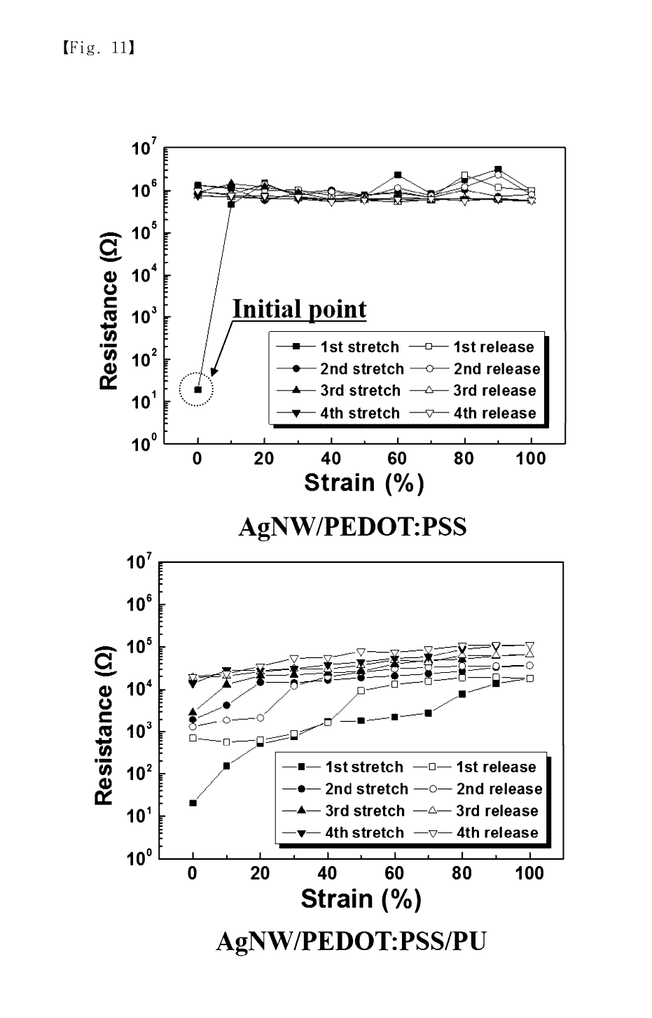

FIG. 11 illustrates test results of a mechanical stability of the strain sensor disclosed herein.

Referring to FIG. 11, to test the mechanical stability, resistance values, which are affected by stretching and compression, of an electrically conductive film containing silver nanowires (AgNW) and PEDOT:PSS (AgNW/PEDOT:PSS, Comparative Example 1) and a presently disclosed nanocomposite layer including AgNW, PEDOT:PSS, and PU (AgNW/PEDOT:PSS/PU, Example 1) were measured. “Initial point” represents an initial resistance value when Comparative Example 1 is not stretched from both sides. “Strain (%)” is a numerical value that denotes a degree to which Comparative Example 1 is stretched; for example, if the length of Comparative Example 1 is 2 cm, a strain of 100% implies that Comparative Example 1 is stretched from both sides until it is elongated to a length of 4 cm. Also, a test was conducted by stretching Comparative Example 1 slowly from both sides to elongate it and then reducing the pulling force so that Comparative Example 1 gradually shortens. “1st stretch” refers to elongation by stretching slowly for the first time, and “1st release” refers to a gradual shortening for the first time. Example 1 was tested in the same manner as the Comparative Example 1.

It was observed that, for Comparative Example 1, the resistance value changed from its initial value of about 10Ω to a range of about 10⁵ to 10⁷Ω when the strain (%) is about 10% or more. In addition, when Comparative Example 1 that has been elongated once is either shortened next time (2nd release) or stretched for the second time (2nd stretch), the resistance value is not restored to the initial resistance value, and that the resistance value is greater than the initial resistance value by at least 10,000 times.

It is postulated that this phenomenon happens because, when a large strain is applied, a strain sensor having metallic nanowires and a polythiophene-based conductive polymer experiences a crack in the material at a certain an upper limit (i.e., elastic limit) or delamination between the metallic nanowires and the conductive polymer, that results in the loss of conductivity. When the upper limit is exceeded, the material is destroyed beyond restoration and the conductivity is not recoverable even when the loading is back to its initial stage. Therefore, in case the sensor is elongated or shortened, the resistance value is not recoverable, and thus, the sensor cannot function as a sensor any longer, and this is confirmed with the fact that a change in resistance does not increase proportionally even when the strain (%) increases.

In contrast to Comparative Example 1, Example 1 tends to recover its initial resistance value even when it is stretched or shortened for the second time (2nd stretch, 2nd release), stretched or shortened for the third time (3rd stretch, 3rd release), or stretched or shortened for the fourth time (4th stretch, 4th release). Example 1 shows a tendency to recover its initial resistance value even after experiencing a deformation, and, even after repetitive stretching and shortening, the resistance value tends to increase proportionally as the strain (%) increases. Example 1, thus, continues to function as a sensor that can measure strain through a resistance change and has an improved mechanical stability, even when after experiencing repeated stretching and shrinkage.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A strain sensor, comprising:
a substrate;
a nanocomposite layer disposed on the substrate, and comprising metallic nanowires, a first polymeric material, and a second polymeric material; and
a protective layer disposed on the nanocomposite layer, and comprising a third polymeric material,
wherein the metallic nanowires are randomly arranged in the nanocomposite layer.

2. The strain sensor of claim 1, wherein the protective layer further comprises one or more of the first polymeric material and the second polymeric material.

3. The strain sensor of claim 1, wherein the first polymeric material is one or more selected from the group consisting of poly(3,4-ethylenedioxythiophene):poly(4-styrenesulfonate) (PEDOT:PSS), polyacetylene, polyparaphenylene, polypyrrole, and polyaniline.

4. The strain sensor of claim 1, wherein the second polymeric material is one or more selected from the group consisting of polydimethylsiloxane (PDMS), ecoflex and polyurethane (PU).

5. The strain sensor of claim 1, wherein the substrate is one or more selected from the group consisting of PDMS, ecoflex, and PU.

6. The strain sensor of claim 1, wherein the third polymeric material is one or more selected from the group consisting of PDMS, ecoflex, and PU.

7. The strain sensor of claim 1, wherein the metallic nanowires comprise gold, silver, nickel, copper, platinum, aluminum, or a combination thereof.

8. A method of manufacturing a strain sensor using a nanocomposite, the method comprising:
forming, on a substrate, a nanocomposite layer comprising metallic nanowires, a first polymeric material, and a second polymeric material; and
forming, on the nanocomposite layer, a protective layer comprising a third polymeric material,
wherein the metallic nanowires are randomly arranged in the nanocomposite layer.

9. The method of claim 7, wherein the forming of a nanocomposite layer comprises:
exposing the substrate to oxygen-plasma;
spin-coating a first solution comprising the metallic nanowires on the oxygen-plasma treated substrate and performing a first heat treatment; and
spin-coating, on the substrate on which the metallic nanowires are randomly arranged, a second solution comprising the first polymeric material and the second polymeric material, and performing a second heat treatment.

10. The method of claim 8, wherein the spin-coating of the first solution is performed at a rotational speed of about 200 to about 400 rpm.

11. The method of claim 8, wherein a concentration of the first polymeric material in the second solution is about 10 to about 50%.

12. The method of claim 8, wherein a concentration of the second polymeric material in the second solution is about 50 to about 90%.

13. The method of claim 7, wherein the forming of a protective layer comprises:
spin-coating a third solution comprising a third polymeric material on the substrate, on which the nanocomposite layer is formed, and performing a second heat treatment.

14. The method of claim 8, wherein the first heat treatment comprises heating at about 50 to about 120° C. for about 10 to about 30 minutes.

15. The method of claim 8, wherein the second heat treatment comprises heating, under a nitrogen (N₂) atmosphere, at about 50 to about 120° C. for about 10 to about 30 minutes and heating at about 120 to about 200° C. for about 60 to about 120 minutes.
